(19) United States
(12) Patent Application Publication
(10) Pub. No.: US 2026/0081483 A1
(43) Pub. Date: Mar. 19, 2026

(54) ELECTRONIC DEVICE WITH FRAGMENTED MAGNETIC ATTACHMENT ASSEMBLY FOR WIRELESS CHARGING

(71) Applicant: Manscaped, LLC, Las Vegas, NV (US)

(72) Inventors: Robert J. Untz, Center, TX (US); Anh Hao Tran, Las Vegas, NV (US); Timothy Richard Swiss, Carlsbad, CA (US)

(21) Appl. No.: 19/327,266

(22) Filed: Sep. 12, 2025

Related U.S. Application Data
(60) Provisional application No. 63/694,713, filed on Sep. 13, 2024.

(51) Int. Cl. H02J 50/90; H02J 50/00; H02J 50/10

(52) U.S. Cl. CPC H02J 50/90; H02J 50/005; H02J 50/10

(57) ABSTRACT

The present disclosure is directed to an improved portable electronic device (e.g., a personal grooming device) having a fragmented (i.e., discontinuous) magnetic attachment assembly for supporting and aligning the device on a wireless charging pad or support pad for a wired recharging connection.

### CROSS-REFERENCE TO RELATED APPLICATION

The present application claims domestic benefit to and hereby incorporates by reference the entirety of U.S. Provisional Patent Application No. 63/694,713 , filed Sep. 13, 2024.

### FIELD OF DISCLOSURE

The present disclosure relates to the field of portable electronic devices with wireless charging capabilities, and more particularly to an improved portable electronic device (e.g., a personal grooming device) having a fragmented (i.e., discontinuous) magnetic attachment assembly for supporting and aligning the device on a wireless charging pad.

### BACKGROUND

Wireless charging devices (e.g., with Qi or Qi2 standards) typically include an inductive coil to wirelessly charge portable electronic devices. Some of these wireless charging devices can support a portable electronic device in an upright (i.e., non-horizontal) orientation. To secure the portable electronic device to the wireless charging device against the force of gravity, some wireless charging devices can include a magnetic ring that magnetically aligns and engages with a corresponding magnetic ring (of identical or similar radius/dimensions) embedded in or attached to the portable electronic device (e.g., in a protective case for an electronic device).

However, for portable electronic devices (e.g., a grooming device) that have narrow form factors, magnetically attaching the portable electronic device to a standard wireless charging device with a conventionally sized magnetic ring proves problematic, since there is no room available in the portable electronic device to include an appropriately-sized magnetic ring. The present inventive concepts address this and other shortcomings of the prior art devices.

### BRIEF DESCRIPTION OF THE DRAWINGS

The electronic device according to the present disclosure is further described with reference to the accompanying drawings, in which:

FIG. 1 is a perspective view of a wireless charging device according to the prior art;

FIG. 2 is a cross-sectional view of a charging pad of the wireless charging device of FIG. 1, taken along the line labeled “2-2”of FIG. 1;

FIG. 3 is a rear view of an embodiment of an electronic grooming device according to the present disclosure, showing a schematic representation of some internal portions of the device; and FIG. 4 is a schematic view of the grooming device of FIG. 3, showing details of a wireless charging assembly.

### SUMMARY

In one respect, the disclosure provides an electronic device comprising a rechargeable battery, a receiver coil adapted to wirelessly receive power from an electromagnetic field and generate current that is transmittable to the rechargeable battery, and a magnetic attachment assembly comprising a plurality of magnets arranged in an annular shape without forming a complete annular array of magnets.

In another respect, the disclosure provides electronic device comprising a rechargeable battery and a magnetic attachment assembly comprising a plurality of magnets arranged in an annular shape without forming a complete annular array of magnets.

### DETAILED DESCRIPTION

The ensuing detailed description provides exemplary example(s) only, and is not intended to limit the scope, applicability, or configuration of the herein disclosed example(s). Rather, the ensuing detailed description of the exemplary example(s) will provide those skilled in the art with an enabling description for implementing the exemplary examples in accordance with the present disclosure. It should be understood that various changes may be made in the function and arrangement of elements without departing from the spirit and scope of the disclosed technology, as set forth in the appended claims.

Many portable electronic devices include a rechargeable battery that can be charged using either a wired and/or wireless charging device. Conventional wireless charging devices include an inductive coil for transmitting power (e.g., from an external power source) wirelessly to a rechargeable electronic device. Moreover, some of these wireless charging devices include a magnet array that can magnetically support portable electronic devices (which further include their own, corresponding magnetic array) from a charging pad of the wireless charging device against, thereby holding the portable electronic device in alignment on the charging pad to ensure good contact for the charging process and/or supporting the portable electronic device on a non-horizontal surface against the force of gravity (e.g., supporting a smartphone from an approximately vertical charging pad for display/improved use purposes). Portable electronic devices often therefore include a corresponding magnet array (either integrally formed with the device or placed within/integral with a storage/protective case for the device) that is shaped and sized to correspond and mate with the magnet array of the wireless charging device. In some cases, the magnet array of a wireless charging device is an industry standard magnetic ring (i.e., annular shape) that is defined by a standard ring outer diameter (e.g., of approximately 54 mm) and a standard ring inner diameter (e.g., of approximately 46 mm). Corresponding magnetic arrays that are included with the portable electronic devices (e.g., smartphones, which are generally flat and wide) are often sized to match the shape (i.e., annular) and size (e.g., 54 mm outer diameter and 46 mm inner diameter) of the magnet array of the wireless charging device.

However, some portable electronic devices can be defined by a device width or a device height that is smaller than a conventional size of magnet arrays for wireless charging devices. For example, a personal grooming device (e.g., a body/head hair trimmer or clipper, nose hair trimmer, face/body shaver, electric toothbrush, or foot callous shaver) can include a device body (e.g., a handle) that is generally slim and defined by a body width that is smaller than a diameter of a magnetic ring of a wireless charger. Accordingly, it can be challenging to fit an industry standard magnetic support ring within the device body of the grooming device.

In some cases, a grooming device can be provided with a full, annular magnet array that fits entirely within a slim device body of the grooming device, but that is sized smaller than the magnet array of an industry standard magnetic ring. While a special purpose charger with a reduced-size magnet array could be designed or provided for the purpose of supporting such a grooming device, such a grooming device could not be supported from (and therefore could not be charged by) existing, upright wireless charging devices that do not match the reduced size of such a magnet assembly. Moreover, other portable electronic devices that include a differently sized (e.g., industry standard 54 mm o.d./46 mm i.d., or larger) magnetic ring may not magnetically align and engage with the special-purpose wireless charger having a differently-sized magnet assembly, therefore reducing the usefulness of such a wireless charging device and increasing clutter and costs for consumers.

Therefore, it is beneficial to provide a portable electronic device with a magnet array that is compatible with a standard wireless charger, notwithstanding a slim device profile of the portable electronic device. The inventors have therefore developed various examples of a “fragmented” (i.e., discontinuous) magnet array for a portable electronic device that includes individual magnets arranged along an annular (e.g., arcuate) path of an industry standard magnetic ring, but that without forming a complete, 360 degree annular magnet array. For example, the magnet array within the portable electronic device can include two magnetic strips that are arranged opposite of each other and spaced apart by a distance that corresponds to the diameters of an industry standard magnetic ring of a wireless charging device. Accordingly, the two magnetic strips can magnetically engage with a magnetic ring of a wireless charging device to attach the portable electronic device to the wireless charging device, while fitting within the narrow body profile of the portable electronic device. Advantageously, the wireless charging device can further support and charge different rechargeable electronic devices (e.g., without the need to provide a different wireless charging device). A consumer could thus, for example, have one industry standard upright wireless charging device in their bathroom that can be used to alternatively charge a smartphone, hair trimmer, and electric toothbrush. Various geometries and applications of the electronic device with magnet array will be described below.

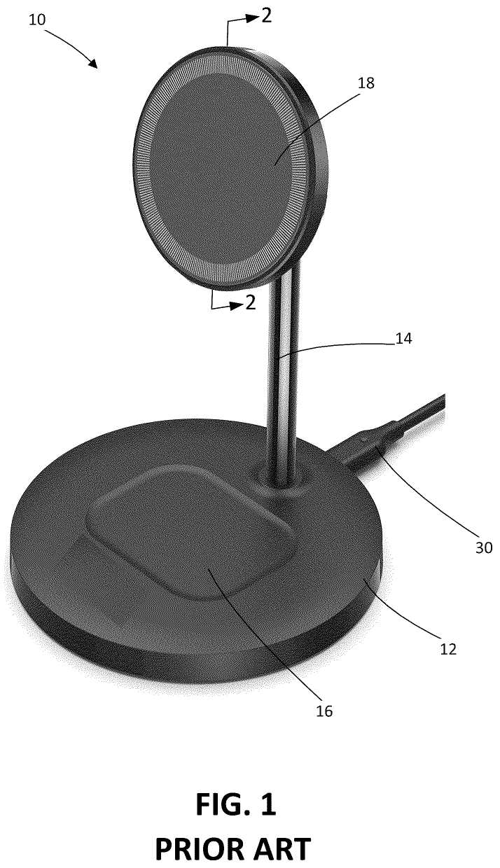

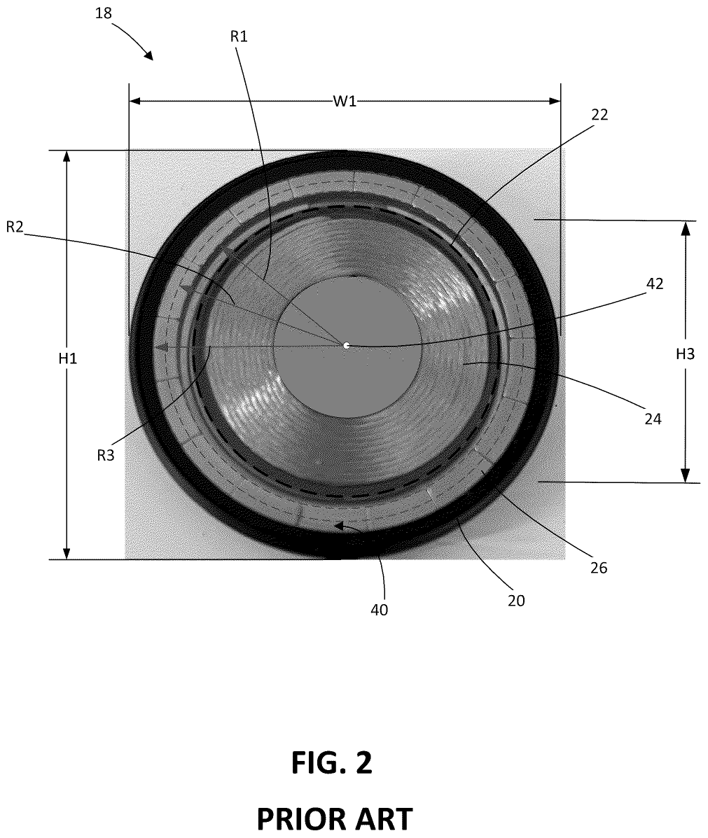

Referring now to FIGS. 1 and 2, one example of a wireless charging device 10 (e.g., a charging dock) according to the prior art is illustrated. In this example, the wireless charging device 10 comprises a base 12, an upright support 14, a charging pad 16, and a charging pad 18. In this example, the charging pad 16 is provided on the base 12 and supports a portable electronic device in a substantially horizontal fashion. The charging pad 18 is supported on the upright support 14 and is oriented generally in a vertical direction. For example, the charging pad 18 can extend perpendicularly relative to the base 12 or a support surface that the wireless charging device 10 is supported on. In some examples, the charging pad 18 can pivotably rotate relative to the upright support 14 (e.g., in a counterclockwise direction or clockwise direction). Thus, the charging pad 18 can support a portable electronic device at an angle relative to the surface on which the wireless charging device 10 is supported. In one example, the wireless charging device 10 can be connected to an external power source (e.g., via a charging cable 30). For example, the charging cable 30 can be coupled to a plug connector that draws power from the external power source and supplies current to the wireless charging device 10, thus powering the charging pads 16, 18.

FIG. 2 is a sectional view taken through the face of the charging pad 18 along line 2-2 of FIG. 1, showing the internal parts of the exemplary charging pad 18. As shown in FIG. 2, the prior art charging pad 18 includes a housing 20 having a center point 42. The housing 20 contains a transmitter coil 24 and a magnet array 26. The housing 20 is defined by a charging pad width W1 and a charging pad height H1. In this example, the housing 20 is circular, and the charging pad width W1 and charging pad height H1 are identical. The transmitter coil 24 is wound in a circular pattern about the center point 42. The transmitter coil 24 defines a charging region 22 having a transmitter coil height H3 that can transmit energy from the wireless charging device 10 to a portable electronic device having an appropriate receiver coil. For example, when the wireless charging device 10 is coupled to the plug connector (e.g., via the charging cable 30), the transmitter coil 24 can receive current from an external power source and generate a magnetic field in the transmitter coil 24, generally in the charging region 22. The magnetic field can engage with a receiver coil of a portable electronic device to produce an electric current in the receiver coil and produce power. Accordingly, the transmitter coil 24 can inductively charge the portable electronic device.

The wireless charging device 10 further includes a magnet array 26 positioned within the housing 20. In this example, the magnet array 26 is concentrically aligned with the transmitter coil 24 and located around the transmitter coil 24. In this prior art example, the magnet array 26 can include a plurality of magnets that are arranged along an annular (e.g., arcuate) path 40, which is one representative positional path for the magnet array 26. For example, the annular path 40 can be defined by an inner radius R1 measured from the center point 42 to the inner edge of the magnet array 26, an intermediate radius R2 measured from the center point 42 to the center of the magnet array 26 (measured in the radial direction), and an outer radius R3 measured from the center point 42 to the outer edge of the magnet array 26. The magnet array 26 is thus positioned between the inner radius R1 and the outer radius R3, with the plurality of magnets forming a magnetic ring along the annular path 40. Thus, when the charging pad 18 is provided in an upright manner (e.g., as shown in FIG. 1), the magnet array 26 can magnetically support a portable electronic device from the charging pad 18 against the force of gravity. In some examples, the magnet array 26 can be an industry standard magnetic ring, which can include: an outer diameter that is about 52 mm, about 53 mm, about 54 mm, about 55 mm, or about 56 mm; an inner diameter that is about 44 mm, about 45 mm, about 46 mm, about 47 mm, or about 48 mm; and/or a radial width that is about 2-14 mm, about 6-10 mm, or about 8 mm.

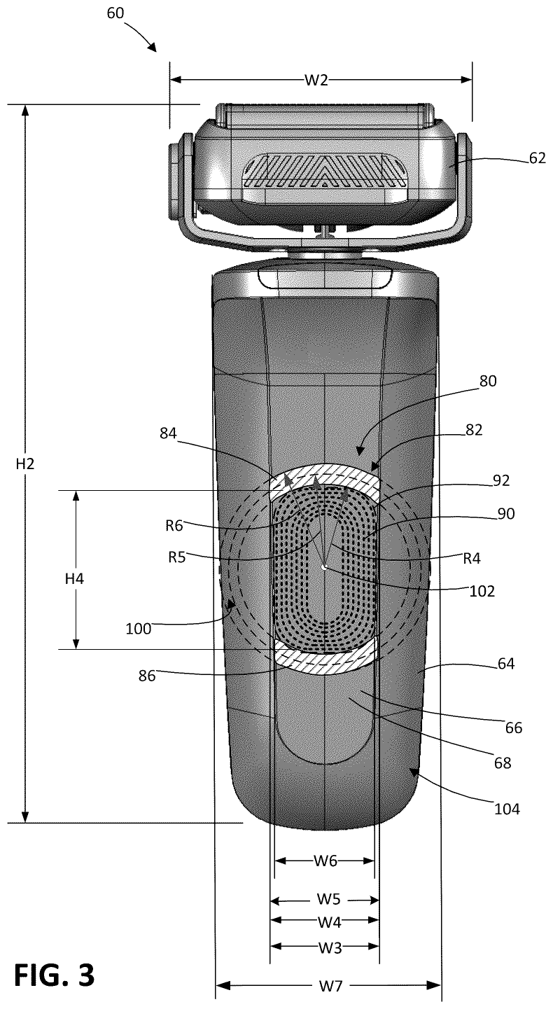

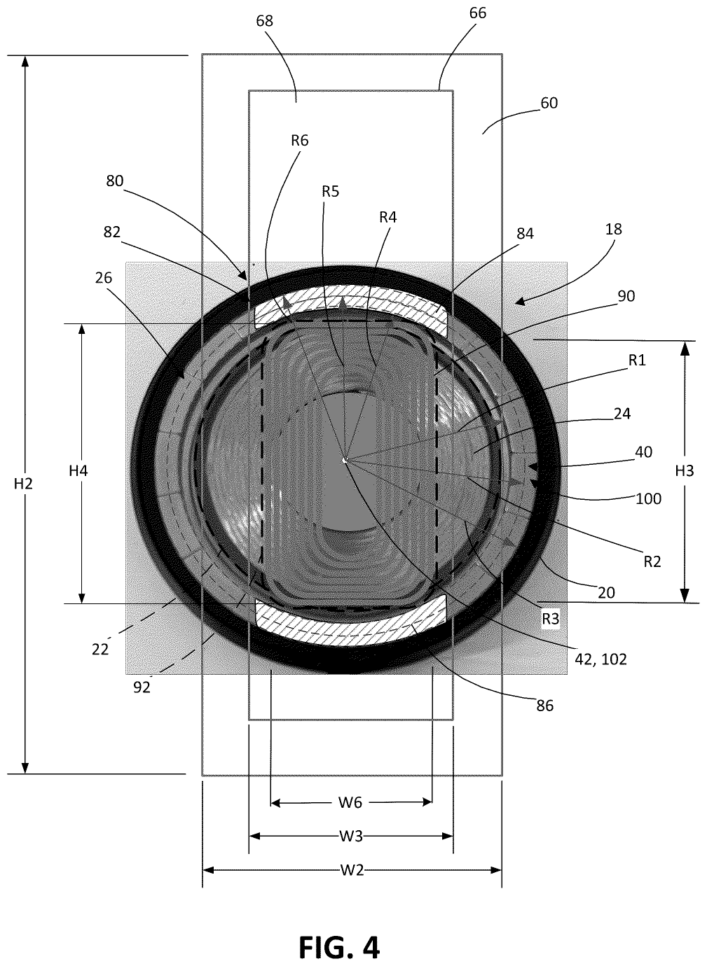

Referring to FIGS. 3 and 4, one example of a representative portable electronic device according to the present disclosure will be described in detail. In this example, the portable electronic device is a grooming device 60 (e.g., shavers, trimmers, razors, etc.). While FIGS. 3 and 4 discuss details of the grooming device 60, the portable electronic device can be any type of rechargeable, portable electronic device, including but not limited to personal hygiene or grooming devices, toothbrushes, flossers, smartphones, audio devices, wearable electronic devices, tablets, portable media players, navigation systems, portable chargers, etc.

In the present embodiment, the grooming device 60 includes a head 62 and a device body 64 that supports the head 62. The head 62 can be interchangeable with different types of heads for different grooming applications. In this embodiment, the grooming device 60 is defined by a device height H2 and a full device width W2. The device height H2 is defined by a combined height of the head 62 and a height of the device body 64. In this example, the full device width W2 can be defined by a widest dimension of the grooming device 60 such as the head 62, although a width of the device body 64 can be greater than a width of the head 62 in some embodiments. Alternatively, the maximum width of the device body W7 could be the operative dimension, as further discussed herein.

The device body 64 can include a device profile that is ergonomically friendly or configured for a user to grab onto (e.g., shaped like or as a handle). In particular, the device body 64 can include various curved or flat surfaces with various dimensions. For example, the device body 64 can include a slim profile or a tapered profile that narrows from a top portion of the device body 64 (e.g., toward the head 62) to a bottom portion of the device body 64. Further, a rear surface 66 of the device body 64 can include a contact surface 68 that is flat and distal surfaces that are generally curved away from the contact surface 68, such that the device body 64 is sized to fit comfortably in a user's hand. The contact surface 68 is defined by a contact surface width W3. In the present embodiment, the contact surface width W3 is considerably less than the full device width W2 and the width W7 of the widest part of the device body 64. In some examples, the contact surface width W3 can be between about 10 mm and about 70 mm, between about 15 mm and about 55 mm, between about 20 mm and about 40 mm, or about 22 mm. In some cases, a maximum width W7 of the device body 64 can be about 20 mm and about 90 mm, between about 40 mm and about 70 mm, between about 50 mm and about 60 mm, or about 55 mm. In various embodiments, both the full device width W2 and the width W7 of the widest part of the device body 64 can be less than the width of a standard wireless charging pad (e.g., charging pad width W1), or at least the width W7 of the widest part of the device body 64 can be less than the width of a standard wireless charging pad (e.g., charging pad width W1).

In this embodiment, the grooming device 60 includes a wireless charging assembly 80. In FIG. 3, elements of the wireless charging assembly 80 are shown schematically overlaid on the exterior of the grooming device 60, but should be understood to be located just interior to a rear surface 66 thereof (i.e., interior to the contact surface 68). In this embodiment, the wireless charging assembly 80 is positioned inside an interior of the grooming device 60, for example mounted on or attached to an interior surface of the rear surface 66 or the contact surface 68. In some embodiments, the wireless charging assembly 80 can be suspended within the interior of the grooming device 60 and may indirectly contact the rear surface 66 or the contact surface 68. In alternative embodiments, one or more portions of the wireless charging assembly 80 can be provided on an exterior 104 of the grooming device 60.

In the present embodiment, the wireless charging assembly 80 comprises a magnet array 82 and a receiver coil 90. As will be discussed in greater detail below, the magnet array 82 can permit magnetic alignment and/or attachment between the grooming device 60 and a wireless charging device (e.g., the wireless charging device 10). The receiver coil 90 can wirelessly receive power from the wireless charging device, thus allowing the grooming device 60 to be charged.

In the present example, the magnet array 82 can be provided along an annular path 100 about a center point 102. The annular path 100 is one representative positional path for the magnet array 82. The annular path 100 is defined by an inner radius R4, an intermediate radius R5, and an outer radius R6, all measured from the center point 102. The magnet array 82 is thus arranged on or between the inner radius R4 and the outer radius R6. In this example, the magnet array 82 can include a first magnet 84 and a second magnet 86. The first magnet 84 and the second magnet 86 can include a generally arcuate profile. For example, a radial length of the first magnet 84 or the second magnet 86 can be defined by 30° to 90° of the annular path 100. Additionally or alternatively, the first magnet 84 is defined by a first magnet width W4, and the second magnet 86 is defined by a second magnet width W5. The first magnet width W4 or the second magnet width W5 can be approximately similar to or smaller than the contact surface width W3. Accordingly, the first magnet 84 and the second magnet 86 can fit within the contact surface 68, and in some embodiments the first magnet 84 and/or second magnet 86 extend to the lateral edges of the contact surface 68. While the magnet array 82 includes two magnets in the present embodiment, a magnet array can include a fewer or greater number of magnets, including one, three, four, five, six, seven, etc. magnets.

The first magnet 84 and the second magnet 86 can be arranged on opposite points of the annular path 100, i.e., diametrically opposed. In particular, the first magnet 84 can be provided on an upper portion of the annular path 100 (e.g., toward a top of the device body 64), and the second magnet 86 can be provided on a lower portion of the annular path 100 (e.g., toward a bottom of the device body 64). Accordingly, respective distances between the first magnet 84 and the second magnet 86 can be defined by doubling the values of the inner radius R4, the intermediate radius R5, or the outer radius R6. In some examples, the distance between the first magnet 84 and the second magnet 86 can be measured by an outer diameter of the annular path 100 (i.e., measured between outer edges of the first magnet 84 and second magnet 86 through the center point 102 of the annular path 100), and the outer diameter can be between about 50 mm and about 60 mm, between about 53 mm and about 57 mm, or about 54 mm. In some examples, the distance between the first magnet 84 and the second magnet 86 can be measured by an inner diameter of the annular path 100 (i.e., measured between inner edges of the first magnet 84 and second magnet 86 through the center point 102 of the annular path 100), and the inner diameter can be between about 40 mm and about 50 mm, between about 42 mm and about 48 mm, or about 46 mm.

In some examples, a size of the annular path 100 can be adjusted (e.g., increased or decreased) to achieve a desired distance between the first magnet 84 and the second magnet 86. In some examples, the distance between the first magnet 84 and the second magnet 86 can be a diameter of an industry standard magnetic ring for a standard wireless charging device (e.g., Qi2 standard). In some examples, locations of the first magnet 84 and the second magnet 86 on the contact surface 68 can be adjusted to achieve a desired distance between the first magnet 84 and the second magnet 86. While the first magnet 84 and the second magnet 86 are opposite of each other, the first magnet 84 and the second magnet 86 need not be directly opposite of each other in some embodiments. For example, the first magnet 84 and the second magnet 86 can be less than 180° apart from each other around the annular path 100.

In some examples, the first magnet 84 and the second magnet 86 can include a substantially similar dimensional profile (e.g., radial width, radial length, thickness, etc.) or magnetic characteristics (e.g., magnetic strength, weight, material, etc.). In some embodiments, the first magnet 84 and the second magnet 86 can include different dimensional profile and magnetic characteristics. In some examples, the first magnet 84 and the second magnet 86 can include permanent magnets, rare earth magnets, pole pieces, ferromagnetic pieces, electromagnets, or other types of magnets. In some cases, respective thicknesses or radial width of the first magnet 84 and the second magnet 86 can be adjusted (e.g., to adjust a magnetic strength or accommodate space within the device body 64). In further alternative embodiments, the magnet(s) need not be arcuate in shape, but could be other shapes—for example a collection of circular or rectangular magnets—and generally located in the appropriate portions of the annular path 100 necessary to correspond to a desired magnet assembly for a wireless charging device.

Further, in this embodiment a receiver coil 90 can be provided concentrically interior to the magnet array 82 (e.g., also centered on the center point 102). The receiver coil 90 can be arranged inside of the annular path 100 and form a charging active area 92. In some embodiments, the receiver coil 90 is defined by dimensions smaller than the annular path 100. For example, the receiver coil 90 is defined by a receiver coil height H4 and a receiver coil width W6. The receiver coil height H4 can be substantially similar to or smaller than the inner diameter of the annular path 100. The receiver coil width W6 can be substantially similar to or smaller than one or more of the contact surface width W3, the first magnet width W4, or the second magnet width W6. In the illustrated example, the receiver coil 90 can be wound in an approximately ovular pattern about the center point 102, although other patterns (e.g., circular, rectangular, trapezoidal, zigzag, etc.) may be possible in other embodiments.

With particular reference to FIG. 4, the grooming device 60 can be positioned on a wireless charging device (e.g., the wireless charging device 10) for wireless charging. In particular, the grooming device 60 can be magnetically attached to the wireless charging device 10 by providing the magnet array 26 and the magnet array 82 in an aligned configuration. Profiles of the annular path 40 and the annular path 100 can be substantially similar, such that when the center point 42 and the center point 102 are aligned (as shown in FIG. 4), the inner radius R1 and the inner radius R4, the intermediate radius R2 and the intermediate radius R5, and the outer radius R3 and the outer radius R6 overlap with one another, respectively. Correspondingly, both of the first magnet 84 and the second magnet 86 are attracted to the magnet array 26 when the grooming device 60 is in a close proximity to the wireless charging device 10. In that configuration, the contact surface 68 is held in contact with the charging pad 18. Thus, the grooming device 60 can be magnetically secured to the wireless charging device 10 at at least two points of attachment. Accordingly, the charging active area 92 can be arranged on the charging region 22, and the induced magnetic field in the transmitter coil 24 can create electric current in the receiver coil 90 to charge a battery of the grooming device 60. In some examples, the receiver coil 90 can receive 5 Watts of power, although a smaller or greater amount (e.g., 18 Watts) of power can be received.

In some cases, a removal force of the grooming device 60 from the wireless charging device 10 may be smaller than a portable electronic device with a magnet array that includes a greater number of magnets or a more full magnetic ring. For example, the removal force of the grooming device 60 can be 1 pound-force or less. Further, the grooming device 60 can be attached to the wireless charging device 10 at any radial orientation relative to the wireless charging device 10. For example, the grooming device 60 can extend horizontally on the charging pad 18 rather than vertically, or any angle in-between vertical and horizontal.

It should be further understood that the inventive concept(s) taught herein with respect to the arrangement of magnetic portions within or on a rechargeable device apply equally to devices that are intended to be recharged via a wired power connection, i.e., that said electronic devices could include magnets therein or thereon as arranged and discussed in the present application, and that these electronic devices could be supported from vertically-arranged mounting stands or bases having annularly-arranged magnets, without the mounting stands or bases being capable of wireless charging of the electronic device. Such vertically-arranged mounting stands or bases could have wired plus or cables integrated therein for charging of the electronic device(s) that are magnetically supportable therefrom.

To aid in describing the disclosure or disclosed technology as claimed, directional terms may be used in the specification and claims to describe portions of the present disclosure or disclosed technology (e.g., upper, lower, left, right, etc.). These directional definitions are merely intended to assist in describing the example(s) and claiming the disclosed technology and are not intended to limit the disclosure or claimed disclosed technology in any way. In addition, reference numerals that are introduced in the specification in association with a drawing figure may be repeated in one or more subsequent figures without additional description in the specification, in order to provide context for other features.

It should be understood that when an element is referred to as being “connected” or “coupled” to another element, it can be integral with the other element, directly connected or coupled to the other element, or that intervening elements may be present. In contrast, when an element is referred to as being “directly connected” or “directly coupled” to another element, it should be understood that no intervening elements are present. Other words used to describe the relationship between elements should be interpreted in a like fashion (e.g., “between” versus “directly between,”“adjacent”versus “directly adjacent,”etc.).

In embodiment(s) described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiment(s) may be combined to form further embodiment(s). For example, variations or modifications described with respect to one of the embodiment(s) may also be applicable to other embodiment(s), unless noted to the contrary.

Unless otherwise specified or limited, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of ±5% or less (e.g., ±2%, ±1%, ±0.5%) inclusive. Where specified in particular, “substantially” can indicate a variation in one numerical direction relative to a reference value. In particular, the term “substantially less” than a reference value (and the like) indicates a value that is reduced from the reference value by 30% or more (e.g., 35%, 40%, 50%, 65%, 80%), and the term “substantially more” than a reference value (and the like) indicates a value that is increased from the reference value by 30% or more (e.g., 35%, 40%, 50%, 65%, 80%).

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Additionally, unless otherwise specified or limited, “substantially coaxial” indicates that the described elements have axes that are substantially parallel with each other and are aligned so that extension of the axis of one of the elements intersects an axial end of another of the elements (e.g., at or within a diameter or other maximum width thereof, within 50% of a diameter or other maximum width thereof, within 25% of a diameter or other maximum width thereof, or within 5%—or less—of a diameter or other maximum width thereof).

In some implementations, devices or systems disclosed herein can be utilized, manufactured, or installed using methods embodying aspects of the disclosed technology. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of. ” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Although exemplary implementations of the herein described systems and methods have been described in detail above, those skilled in the art will readily appreciate that many additional modifications are possible in the exemplary examples without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. An electronic device comprising:
a rechargeable battery;
a receiver coil adapted to wirelessly receive power from an electromagnetic field and generate current that is transmittable to the rechargeable battery; and
a magnetic attachment assembly comprising a plurality of magnets arranged in an annular shape without forming a complete annular array of magnets.

2. The electronic device of claim 1, the plurality of magnets consisting of two magnets which are diametrically opposed within the annular shape.

3. The electronic device of claim 2, the electronic device further comprising a housing including a contact surface, wherein the two magnets extend to lateral edges of the contact surface.

4. The electronic device of claim 2, wherein the two magnets are spaced apart by a distance that corresponds to the diameters of an industry-standard magnetic ring of a wireless charging device.

5. The electronic device of claim 4, wherein the distance is between 44-48 millimeters measured between respective inner edges of the two magnets.

6. The electronic device of claim 4, wherein the distance is approximately 46 millimeters measured between respective inner edges of the two magnets.

7. The electronic device of claim 4, wherein the distance is approximately 52-56 millimeters measured between respective outer edges of the two magnets.

8. The electronic device of claim 4, wherein the distance is approximately 54 millimeters measured between respective outer edges of the two magnets.

9. The electronic device of claim 1, the electronic device further comprising a device body having a profile that tapers in width between a top portion thereof and a bottom portion thereof.

10. The electronic device of claim 1, wherein each of the magnets of the plurality of magnets covers between 30 degrees and 90 degrees of an available 360 degrees of the annular shape.

11. An electronic device comprising:
a rechargeable battery; and
a magnetic attachment assembly comprising a plurality of magnets arranged in an annular shape without forming a complete annular array of magnets.

12. The electronic device of claim 11, the plurality of magnets consisting of two magnets which are diametrically opposed within the annular shape.

13. The electronic device of claim 12, the electronic device further comprising a housing including a contact surface, wherein the two magnets extend to lateral edges of the contact surface.

14. The electronic device of claim 12, wherein the two magnets are spaced apart by a distance that corresponds to the diameters of an industry-standard magnetic ring of a wireless charging device.

15. The electronic device of claim 14, wherein the distance is between 44-48 millimeters measured between respective inner edges of the two magnets.

16. The electronic device of claim 14, wherein the distance is approximately 46 millimeters measured between respective inner edges of the two magnets.

17. The electronic device of claim 14, wherein the distance is approximately 52-56 millimeters measured between respective outer edges of the two magnets.

18. The electronic device of claim 14, wherein the distance is approximately 54 millimeters measured between respective outer edges of the two magnets.

19. The electronic device of claim 11, the electronic device further comprising a device body having a profile that tapers in width between a top portion thereof and a bottom portion thereof.

20. The electronic device of claim 11, wherein each of the magnets of the plurality of magnets covers between 30 degrees and 90 degrees of an available 360 degrees of the annular shape.
